(19) United States
(12) Patent Application Publication
(10) Pub. No.: US 2012/0240673 A1
(43) Pub. Date: Sep. 27, 2012

(54) WHEEL LOCK-UP, SKID INDICATOR

(76) Inventor: Robert M. VOGT, Calgary (CA)

(21) Appl. No.: 13/406,646

(22) Filed: Feb. 28, 2012

(30) Foreign Application Priority Data
Mar. 23, 2011 (CA) 2735482
Oct. 27, 2011 (CA) 2756356

(51) Int. Cl. G01M 17/02

(52) U.S. Cl. 73/146.8

(57) ABSTRACT

A replaceable wheel lock-up indicator attaches to an outer edge of a rim of a wheel of a vehicle. The indicator has a mount for mounting the indicator to the outer edge and a neck for extending a highly visible resilient planer flag beyond a plane defined by a sidewall of the tire. The mount comprises a fluid passageway and a fluid drain for draining melt water away from the mount. The neck has an angle sufficient to position the flag substantially parallel to the plane defined by the sidewall permitting a planer indicator surface to be viewed by a driver seated in the driver's cabin of the vehicle. The indicator surface is contrasted against the sidewall of the tire for increasing visibility thereof.

### CROSS REFERENCE OF RELATED APPLICATIONS

This application claims the benefits under 35 U.S.C 119(d) of the Canadian Applications Serial No. 2,735,482, filed on Mar. 23, 2011, and Serial No. 2,756,356, filed on Oct. 27, 2011, which are incorporated fully herein by reference.

### FIELD OF THE INVENTION

Embodiments of the invention relate to a wheel lock-up indicator. More particularly, embodiments of the invention relate to an indicator for releasable mounting to an outer edge of a rim of a wheel, the indicator being amenable to tire flexibility and being viewable against a sidewall of the tire by a driver seated in a driver's cabin of the vehicle.

### BACKGROUND OF THE INVENTION

A common problem with vehicles, such a semi-trailers operating in winter conditions, is the locking up of wheels and detection thereof. Wheel lock-up on a vehicle equipped with air-to-disengage brakes, more commonly known as air brakes, is known, particularly for vehicles operating in cold conditions. Wheel lock-up can occur when moisture from condensed air freezes and block air from operating the brake mechanism. As a result, the brakes engage or fail to disengage. In certain circumstances, tire lock-up can result in skidding, and loss of control of the vehicle. Skidding of a tire typically results in sudden and uneven wear of the tire. If a tire skids for longer periods of time, flat spots of the tire can be created. A flat spot on a tire can occur even within 200 feet of dragging of the tire. Flat spots or uneven wear on a tire results in changes to the circumference of the tire and/or the torque specifications of the wheel. Such changes can increase the stress on the hub of the wheel, the studs holding the wheel onto the axle, and to the rim.

To help a driver determine if a wheel is rotating or locked up, it has been known to paint radially-extending lines on the sidewall of each tire. Typically, a driver of a semi-trailer is seated above the tires, and accordingly has the side mirrors turned inward to view down along the entire length of a trailer being towed so as to view or observe the sidewalls of every tire on the trailer. As the tires rotate, the radial lines, typically white, are seen by the driver as a blurred, continuous white ring. In the event of a wheel lock-up, the radially-extending white lines are static, and would not be seen. Painting lines on a sidewall of a tire is undesirable for several reasons. Firstly, radially extending white lines on an otherwise black tire are not aesthetically pleasing. Secondly, the painted lines are also susceptible to fading over time, reducing their effectiveness. Furthermore, white lines are typically not very visible in low light conditions and may at times be difficult to see by a driver in their usual position seated in the driver's cabin of the truck.

Some problems associated with using painted lines as an indicator for wheel lock up were overcome by attaching or mounting physical indicators onto the tire themselves. In U.S. Pat. No. 4,194,810 to Eller, a truck tire safety reflector comprising a reflective convex body is secured to an outer edge of a rim of a wheel by a clip member. The reflector has a first reflective surface which is substantially parallel to the plane of the sidewall of the tire and a second reflective surface which extends transversely of that plane. As the tire rotates, light is reflected off the first surface and the driver sees a blurred, continuous lighted ring.

Eller's reflector is disadvantageous because the reflective surfaces, both parallel to the plane of the sidewall of the tire and transverse to the plane, require light to reflect off for the driver to visualize it. Further, reflected light can also be a cognitive distraction to other drivers on the road. Multiple reflective surfaces that are constantly rotating can be a distraction which can lead to accidents. Further still, the second reflective surface that is transverse to the plane of the wheel can also obstruct the view of another reflector secured to a wheel therebehind.

Eller's reflector can also be lost when used in cold winter conditions. As commonly known by drivers who operate vehicles in winter environments, snow can accumulate within the hub of a wheel. However, when brakes are applied, heat generated from the brakes can be sufficiently high enough to cause the accumulated snow to melt and run or drain along the outer edge of the rim. The melt water can accumulate between the outer edge of the rim and mounting means. The accumulated melt water re-freezes, expanding in volume, and forces the reflector off the rim.

Eller's reflector may also susceptible to be forced off the rim by lateral flexing movement of the tire, such as during cornering. Resting on the sidewall of the tire, any lateral movement of the sidewall of the tire rotates Eller's mounting means, prying the reflector off the rim.

U.S. Pat. No. 4,635,583 to Cox discloses a tire skid detector which overcomes several problems associated with Eller's reflector. Cox's tire skid detector is mountable to a hub of the wheel comprising a strip extending diametrically across the wheel and having a pair of diametrically opposed legs projecting laterally outwardly and fit generally within the rim itself. Cox has an indicator surface at the end of each of the diametrically opposed legs to project slightly beyond the tire sidewall and which are observable by a driver when the tire is viewed in a direction transversely to the rotary axis thereof. However, when the tire skid detector is viewed from the driver's cabin by a driver in their normal driving position, the skid indicator is not as easily observable and then only as a thin, narrow ring. Accordingly, Cox increases the visibility of the thin, narrow ring by fitting the end indicator surfaces with light reflecting substances. Like Eller, the light reflecting surfaces may be a cognitive distraction.

U.S. Pat. No. 6,048,068 to Broten also discloses a wheel rotation marker having a reflective end. Broten's marker is a unitary strip of material (preferably plastic) mounted on a wheel stud and extends axially away from the wheel. When Broten's marker is secured to a stud of the wheel, the marker is pressed between the rim and the wheel nut causing a reflective end to rest on an outer edge of the rim. Similar to Cox, the reflective end extends beyond a plane defined by the tire sidewall and is visible by a driver when viewed in a direction transverse to the axis of rotation of the wheel. Unfortunately, Broten's marker can suffer the same disadvantage as Cox in that the reflective end is not as easily observable by a driver seated in the cabin. Broten's reflective end is only seen as a thin, narrow ring and can be a cognitive distraction.

### SUMMARY OF THE INVENTION

A replaceable tire skid indicator, mounted to an outer edge of a rim of a wheel, can be observed or seen against a sidewall of a tire, by a driver seated in the driver's seat of a vehicle. In replacing the prior art painted lines with a replaceable indicator, Applicant overcame challenges to the mounting arrangement, effects of tire flex and movement, and visibility. Generally, the indicator is mounted to the rim and a planer flag extends generally radially therefrom. A neck connects the rim mount and flag. The mount can be fit with a fluid drain to shed melt water when parked. In one form, the mount is formed of a strong, resilient material suitable for dependably gripping the rim while the flag material is of a different material that is sufficiently flexible to yield to sidewall movement without the mount from the rim. In another form, the mount and flag are of like strong, resilient material and the flag is spaced from the sidewall sufficiently to accept sidewall movement. As the wheel rotates, the flag appears to the driver as a blurred continuous ring lying in front of the tire sidewall. The flag can be of a non-reflective, high visibility color to further increase the contrast between the flag and the sidewall of the tire for increasing visibility thereof.

In a broad aspect of the invention, a replaceable tire skid indicator for indicating lock-up of a wheel comprises a mount for mounting the indicator to the outer edge and a planer flag operatively connected to the mount and having an planer indicator surface, substantially parallel to the tire's sidewall and visible to the driver. The mount has a fluid passageway along the rim's outer edge for permitting melt water flowing along the outer edge to drain away through the mount.

In another aspect of the invention, a replaceable tire skid indicator comprises a mount for releasably mounting the indicator to the rim's outer edge. The mount includes a fluid passageway, formed in the mount between the rim's outer edge and the mount. A planer flag is operatively connected to the mount and having a planer indicator surface visible to the driver, the planer flag extending generally radially along and substantially adjacent a sidewall of the tire. A fluid drain is formed between the fluid passageway and an exterior of the indicator, wherein water flowing along the rim's outer edge is conducted along the fluid passageway to the fluid drain to drain water away from the rim's outer edge and mount to an exterior of the indicator.

In another aspect, the indicator comprises a mount for mounting the indicator to the rim's outer edge, the mount having a U-clip having first and second gripping extensions, at least one of which is resilient, the first and second gripping extensions releasably gripping the rim's outer edge; and a planer flag operatively connected to the mount and having a planer indicator surface visible to the driver, the planer flag extending generally radially along and substantially adjacent to a sidewall of the tire at least the flag being flexible for accommodating lateral movement of the sidewall of the tire during tire rolling. In one aspect, the mount and flag are formed of different materials, the flag being more flexible than that of the mount. In another aspect, a thickness of the flag is tapered, being thicker at an end proximal to the mount and becoming thinner towards a distal end for permitting flexing of the flag for accommodating lateral movement of the sidewall of the tire during rolling.

### BRIEF DESCRIPTION OF THE FIGURES

FIG. 1 is a schematic representation of a semi-trailer having its side mirrors oriented to view all of the sidewalls of each tire and the skid indicators thereon along the entire length of the trailer being pulled;

FIG. 2A is side view of a prior art indicator mounted to a rim of a wheel;

FIG. 2B is a front view of the indicator of FIG. 2A, illustrating the indicator resting on the sidewall of the wheel and an indicator surface being visible in a direction transverse of the axis of rotation of the wheel;

FIG. 3A is a side view of a prior art indicator mounted to a hub of a wheel;

FIG. 3B is a front view of the indicator of FIG. 3A, illustrating an indicator surface extending beyond a plane defined by a sidewall of the tire and visible in a direction transverse of the axis of rotation of the wheel;

FIG. 4A is a side view of a prior art indicator mounted to a wheel nut;

FIG. 4B is a front view of the indicator of FIG. 4A, illustrating the indicator being visible in a direction transverse of the axis of rotation of the wheel;

FIG. 5A is a side view of an embodiment of the present invention, illustrating an indicator mounted to an outer edge of a rim of a wheel and visible against a sidewall of a tire;

FIG. 5B is a front view of the indicator in accordance to FIG. 5A, illustrating a flag being positioned substantially adjacent the sidewall of the tire and substantially parallel to a plane defined by the sidewall;

FIG. 5C is a fanciful view of rear axles of a trailer as viewed by the driver through the passenger side-view mirror, the rear tire having locked up and the second last rear tire still rotating and showing a blurred indicator;

FIG. 6A is a side view of a tire for a parked vehicle, with melt water flowing down the rim to a lower indicator;

FIG. 6B is a side view of an indicator, such as that of FIG. 6A, illustrating the rim mount, location of drain port and arrangement adjacent a tire sidewall;

FIG. 6C is a close-up view of the indicator of FIG. 6A, ilustradting the shedding of melt water through a fluid drain;

FIG. 7 is a side perspective view of the embodiment in accordance to FIG. 6C, illustrating an indicator surface and drainage passageways;

FIG. 8 is a side cross-sectional view of the embodiment in accordance to FIG. 6A, illustrating the mounting means having two gripping extensions and a drainage passageway through the mounting means;

FIG. 9 is another side perspective view of the embodiment in accordance to FIG. 6A, illustrating the flag being tapered in thickness and having gussets along lateral sides of the flag;

FIG. 10A is a schematic representation of an embodiment of the present invention illustrating a tire skid indicator having an angle sufficient to space the indicator away from a sidewall of a tire;

FIG. 10B is a schematic representation of the embodiment in accordance to FIG. 10A, illustrating lateral movement (in dotted lines) of the sidewall of the tire during rolling and the skid indicator avoiding the lateral movement;

FIG. 10C is a schematic representation of an embodiment of the present invention illustrating a tire skid indicator resting on a sidewall of a tire; and

FIG. 10D is a schematic representative of the embodiment in accordance to FIG. 10C, illustrating flexing (in dotted lines) of the sidewall and skid indicator to accommodate lateral movement of the sidewall of the tire during tire rolling.

### DETAILED DESCRIPTION OF THE INVENTION

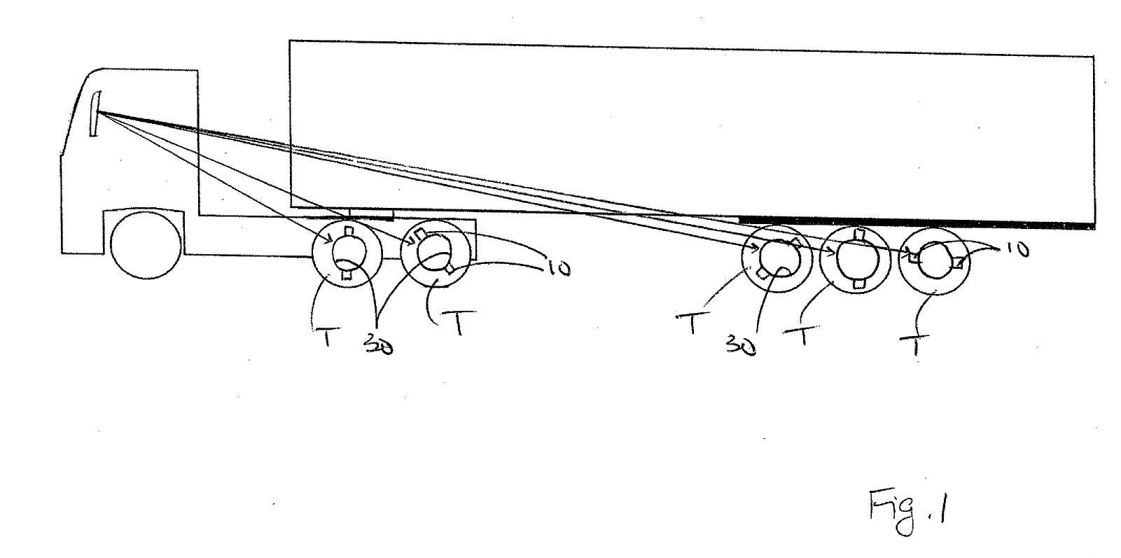

With reference to FIG. 1, tire skid indicators should be easily and readily visible to a driver of a vehicle whilst the vehicle is in motion. As commonly practiced, drivers often position their side mirrors inwardly to view down along the entire length of their trailer to quickly observe and determine if all of the wheels on the trailer are rotating. Any delay in being able to determine if a wheel is locked-up and/or skidding can unnecessarily increase the risk of equipment failure or accident.

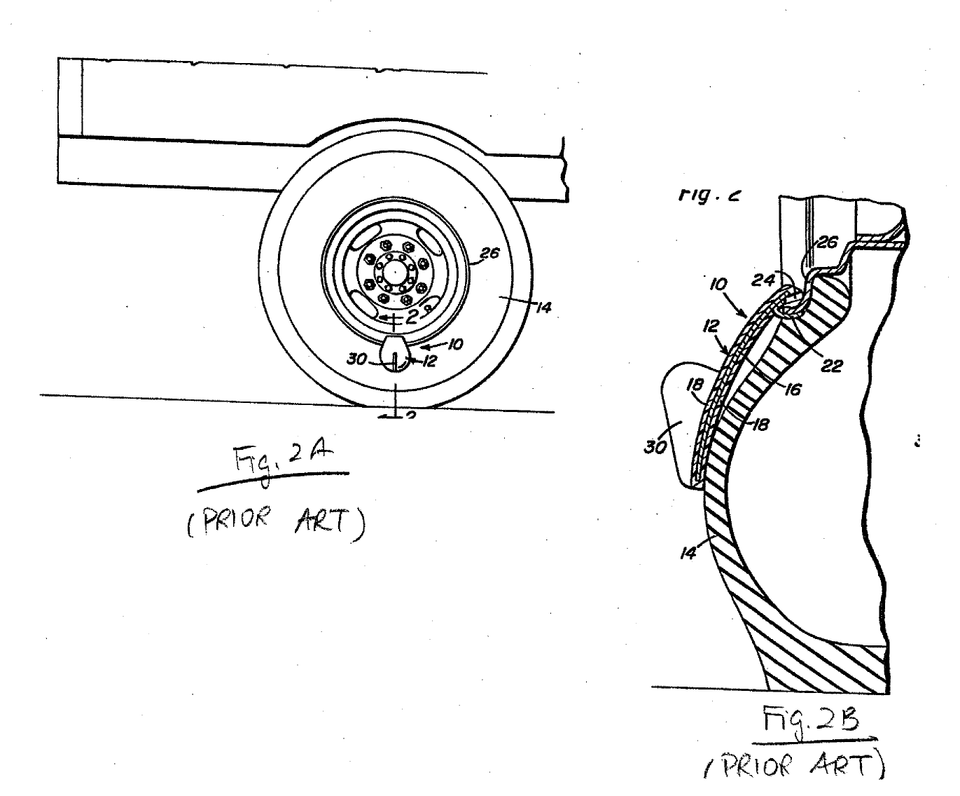

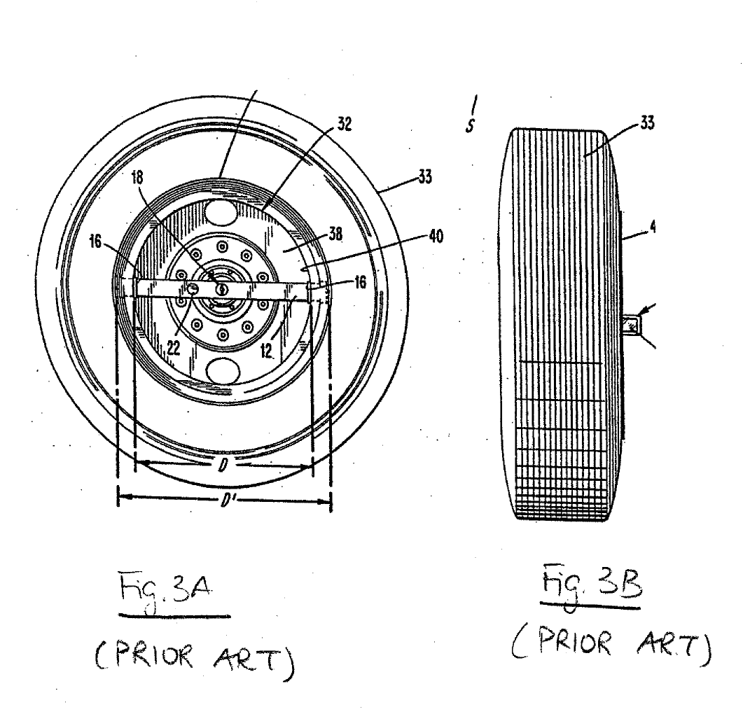

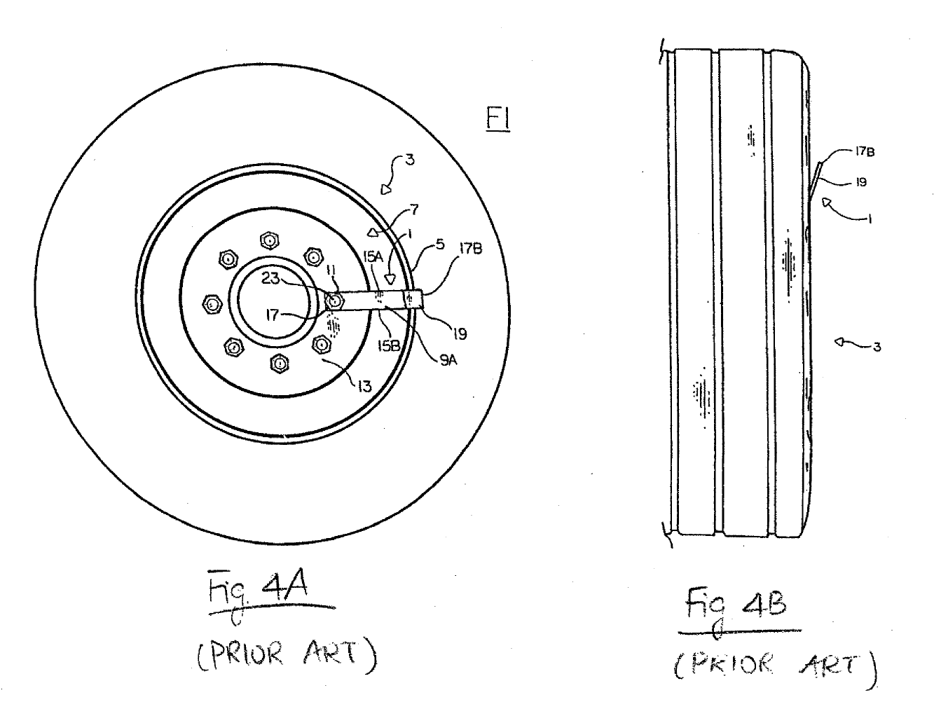

With reference to FIGS. 2A to 4B, prior art indicators of U.S. Pat. No. 4,194,810 to Eller can be mounted to a rim of each wheel of the vehicle in a variety of manners. As shown, each indicator has a flag that extends beyond a plane defined by a sidewall of the tire of each wheel. The flag has a viewing or indicator surface perpendicular to the tire sidewall. The prior art indicator shown in FIGS. 3A and 3B in U.S. Pat. No. 4,635,583 to Cox is a generally U-shaped strip mounted to a wheel. The prior art indicator shown in FIGS. 4A and 4B in U.S. Pat. No. 6,048,068 to Broten, is mounted to a wheel nut, projects generally radially and laterally to rests on an outer edge of the rim of the wheel.

### Embodiments of the Skid Indicator

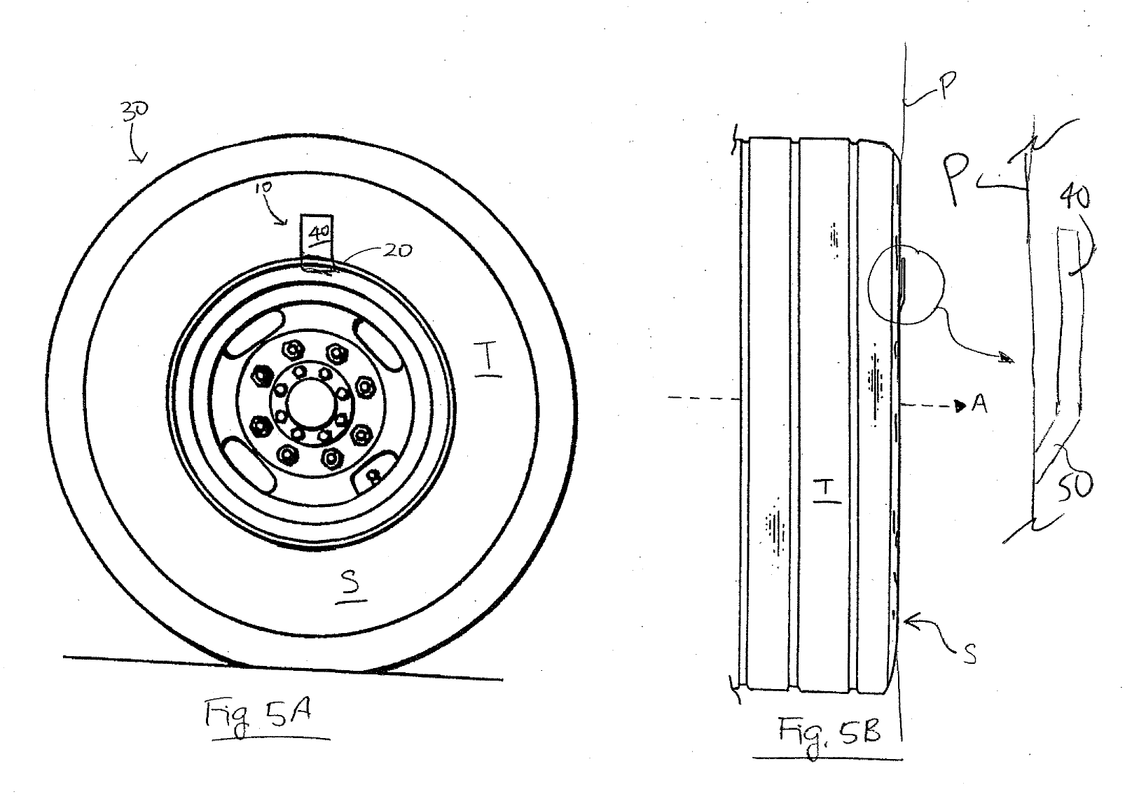

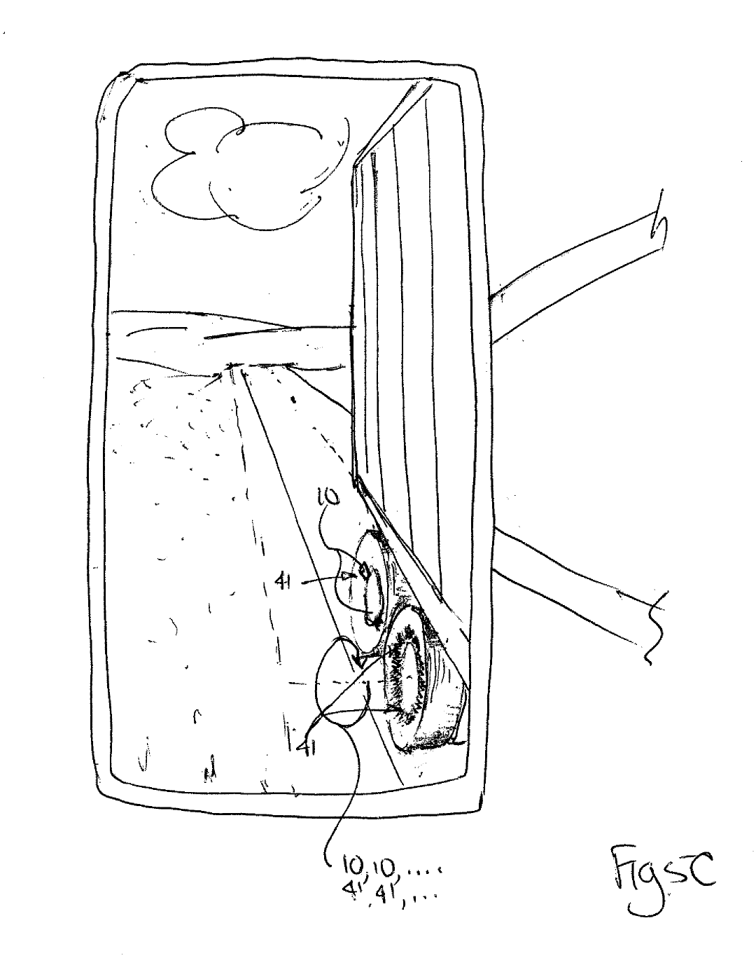

Turning to a description of embodiments of the current indicator, and with reference to FIGS. 5A and 5B, an indicator 10 is releaseably or replaceably mountable onto a rim 20 of a wheel 30. The indicator 10 further comprises a flag 40 which extends generally radially along and substantially adjacent to a sidewall S of the tire T. The flag can extend laterally beyond a sidewall plane P defined by a sidewall S of a tire T. The indicator 10 is mounted to as to arrange the flag 40 positioned substantially adjacent and radially along the sidewall S of the tire T, extending radially away from an axis of rotation A of the tire T. When mounted to a rim 20, the flag 40 has a visible surface 41, generally parallel with the sidewall plane P and faces generally away from the sidewall S. As shown in FIG. 5C, the flag's visible surface 41 can be observed through the shallow angle provided by the truck's side-view mirrors.

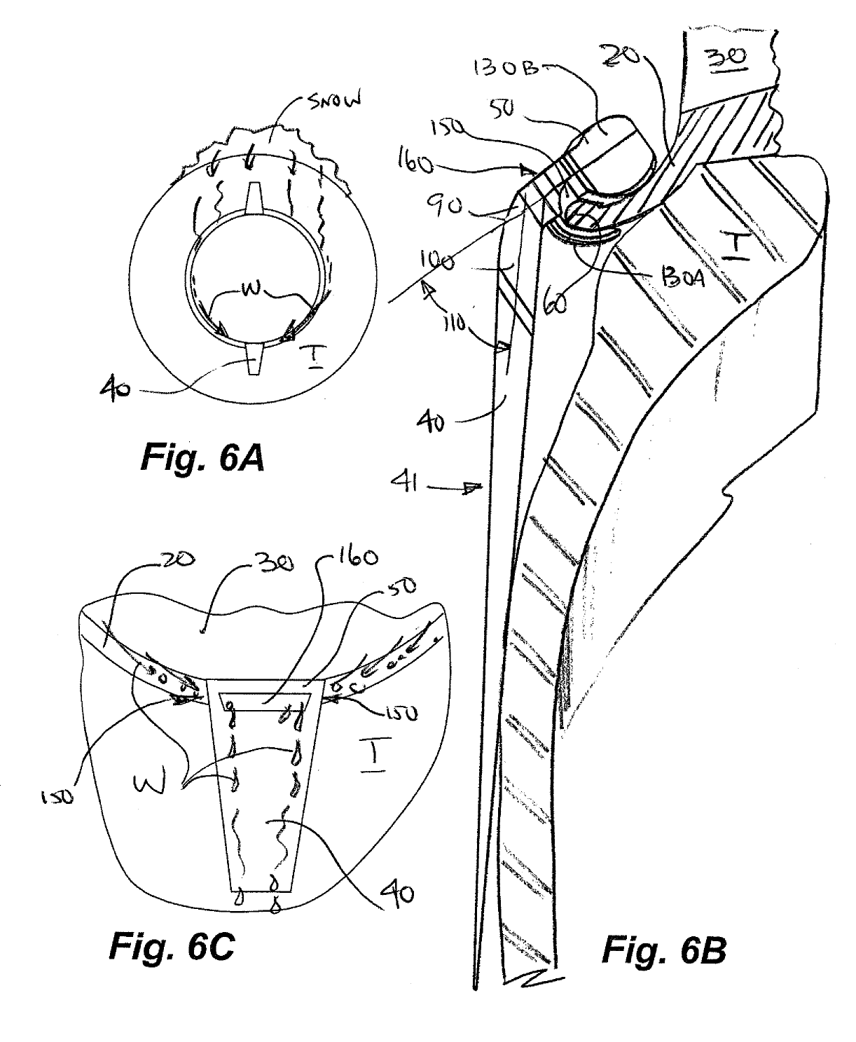

As more clearly shown in FIG. 6B, an embodiment of the replaceable tire skid indicator 10 can comprise mounting means or rim mount 50 for mounting the indicator 10 to the rim's an outer edge 60. A proximal end 90 of a neck 80 is connected to the rim mount 50, while a distal end 100 of the neck 80 connects to the flag 40. As shown, the neck 80 has a bend or angle 110 that is sufficient to align the flag 40 generally parallel to the sidewall S (see FIG. 5B).

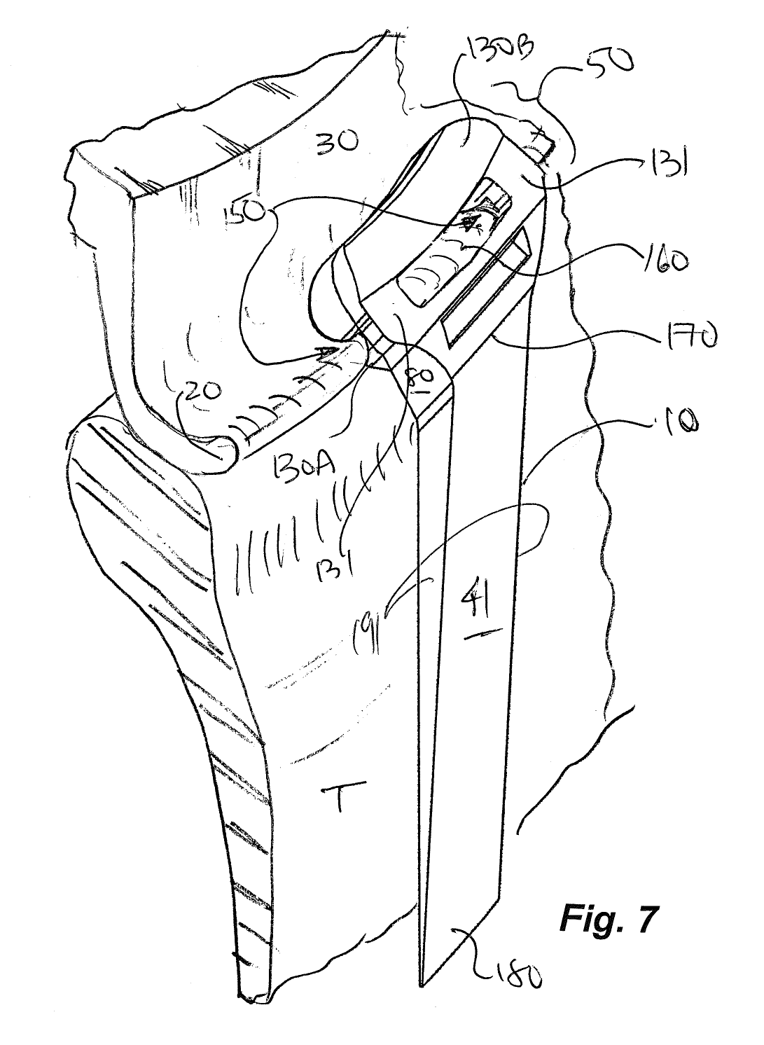

With reference to FIG. 7, the flag 40, when viewed as if it was mounted to the rim's outer edge 60, has an observable planer indicator surface 41 that extends from about the distal end 100 of the neck 80 along the entire length of the flag 40. Referring back to FIGS. 5A, 5B and 6, the angle 110 in the neck 80 positions the planer indicator surface 41 to be generally parallel and substantially adjacent to sidewall S. The indicator surface 41 can be viewed or seen against a typical black colored sidewall S of the tire T. The surface 41 can be angled laterally somewhat outside the sidewall plane P.

In an embodiment, the indicator surface 41 can be of a non-reflective, high visibility color (commonly known as “high visibility orange” used for safety equipment) which can be contrasted against a typically black and grey colored sidewall. Accordingly, as the vehicle moves and the wheel rotates, the rotating tire appears to be black having an blurred, continuous, orange ring thereon. The contrast between the color of the planer indicator surface and the black sidewall increases the visibility of the indicator 10. The surface 14 part of the flag 40 is always visible to the driver for two reasons, one being that the mirrors on a truck are mounted about 14 inches outward from the cab and are turned inward to view down the entire length of the trailer. While wheels are always visible from the cab, it is hard to determine whether they are all turning without careful study which takes your concentration away from the road. As stated, with indicator 10, the sidewall S of the tire T will appear orange to the driver.

While not recommended for the risk of cognitive effect, the Applicant notes that the planer indicator surface can be reflective as it is facing laterally from the wheel and not oriented directly at the driver as is the case in the prior art. Applicant believes that the use of reflective surfaces has the risk of causing cognitive distractions to the driver or particularly other drivers sharing the roadways.

Once again referring back to FIG. 5B, when the replaceable tire skid indicator 10 is mounted to the rim 20, the neck 80 extends the flag 40 generally radially along and laterally outside the sidewall S. The angle 110 in the neck 80 is of a sufficient angle to position the flag 40 substantially adjacent and align the planer indicator surface 41 generally parallel to the plane P. As a result, the indicator surface 41 is contrasted against the sidewall S and can be easily observed by the driver seated in the driver's cabin. Depending on the length of the indicator 10, the flag 40 can extend beyond the sidewall plane P.

Referring to FIG. 6B, the rim mount 50 can be a clip having first and second gripping extensions 130A, 130B, at least one of which being resilient, that securely yet releasably grip the rim's outer edge 60 therebetween. The two opposing gripping extensions 130A, 130B together form a U-clip having a sloped U-shaped profile having an arcuate recess or base 140 for accepting the outer edge 60 therein.

With reference to FIGS. 6A, 6B and 6C, in one embodiment, when the indicator 10 is securely mounted to the rim 20, the outer edge 60 does not fully engage against the base 140, being spaced apart for forming a fluid passageway 150 along the base of the mount. Particularly when parked, melt water W, such as that from accumulated snow or snow and ice fallen from the trailer suspension can melt and water W flows down the tire and around the rim's outer edge 60. When parked and where an indicator 10 is positioned low on the tire rotation, water W can be dammed up at the mount 50 and if the water refreezes, pry the mount free of the rim 20. Accordingly, the fluid passageway 150 permits water to flow along the rim's outer edge 60 and through the indicator 10. A drain opening or fluid drain 160 is provided in the mount 50, for receiving melt water flowing through fluid passageway 150 and draining the melt water down the flag 40, away from the mount 50.

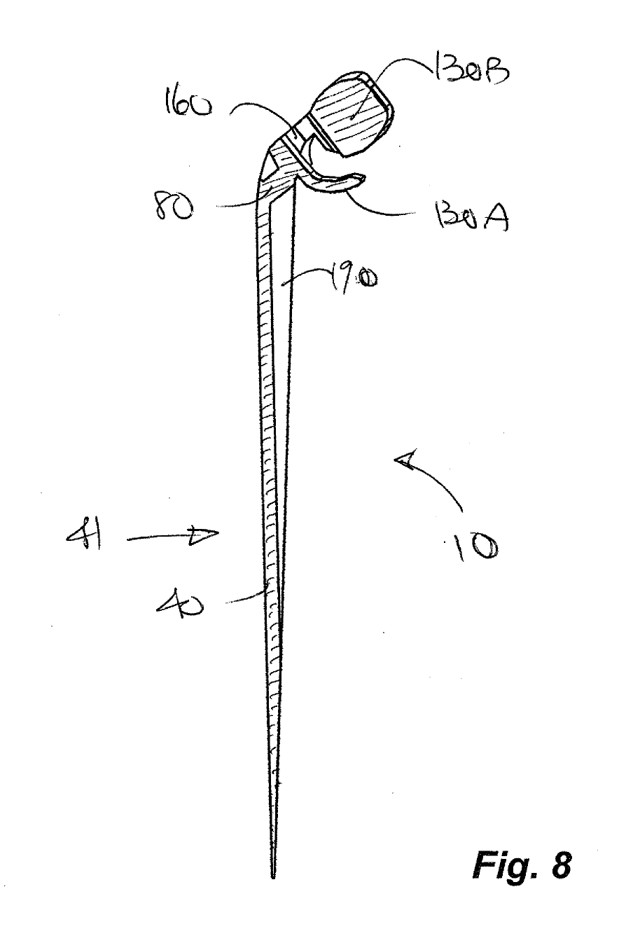

With reference to FIGS. 7 and 8, the fluid drain 160 extends through the mount 50 between the base 140 of the mount 50 and an exterior of the mount 50 for permitting water flowing along the rim's outer edge 60 to pass therethrough.

Accordingly, water flowing along the rim's outer edge 60 can be conducted along the fluid passageway 150 to the fluid drain 160 to drain water away from the outer edge 60 and the mount 50. The fluid passageway 150 and fluid drain 160 permit melt water W to drain therethrough and not accumulate between the mounting means 50 and the outer edge 60 of the rim. Without any accumulation of water therebetween, any problems associated with re-freezing of melted snow and the forcing off of the indicator is obviated.

As shown in FIG. 7, the mount therefore comprises resilient gripping extensions 130A, 130B supported in a structure having sidewalls 131,131 for bracketing the fluid drain 160. The sidewalls 131 are recessed for forming the arcuate base 140. The combination of the arrangement of the gripping extenstions 130B,130A and arcuate base 140 with the rim's outer edge 60 form the fluid passageway 150.

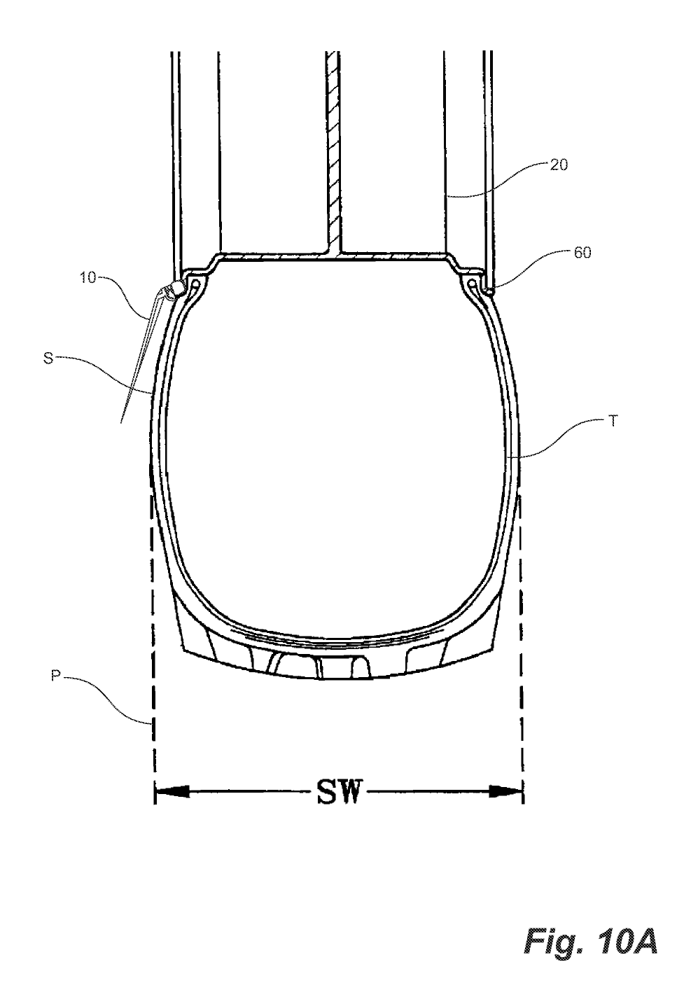

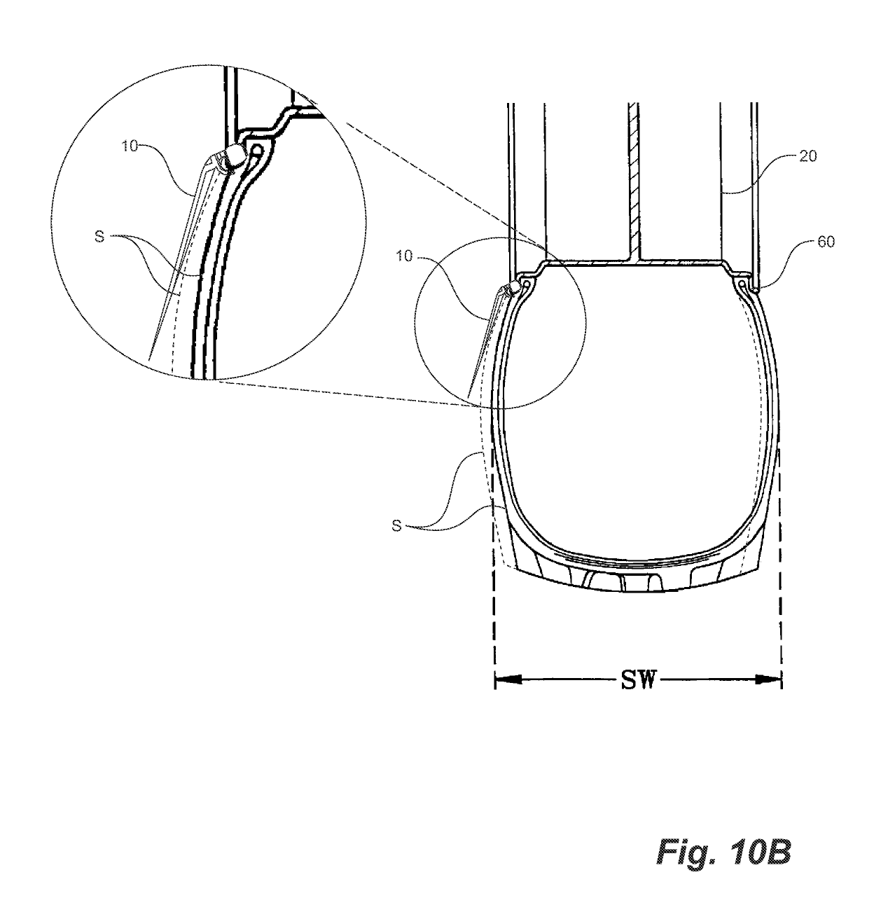

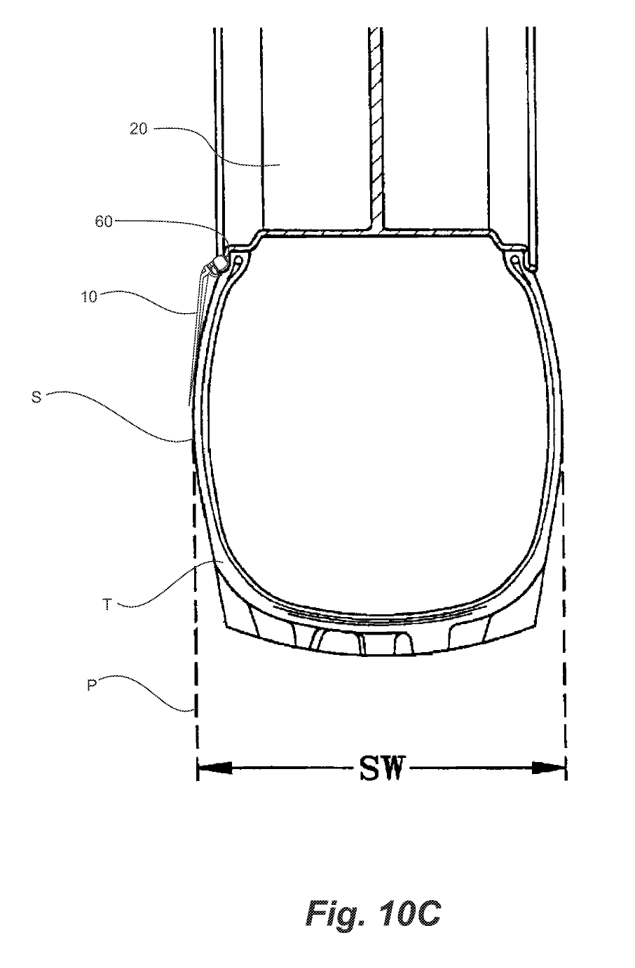

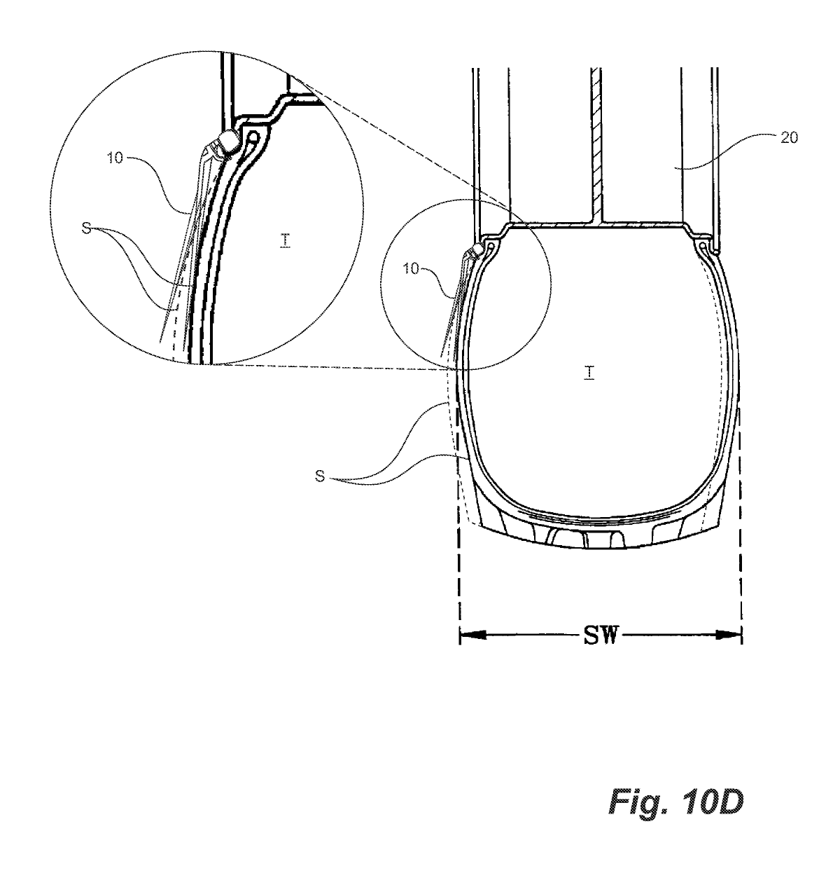

In an embodiment, and as shown in FIGS. 5B, 10A and 10B, the flag 40 can be spaced away from the sidewall S of the tire T. As shown, the angle 110 in the neck 80 can be sufficient enough to position the flag 40 adjacent the sidewall S of the tire T, but be spaced away from the sidewall S so as to provide sufficient space between the sidewall S and the flag 40 to substantially avoid engaging the sidewall S during any lateral movements which can result from tire rolling such as during cornering. FIG. 10B illustrates how the space between the flag 40 and the sidewall S of the tire T can be sufficient enough to substantially avoid engagement with the sidewall S and lateral movement of the flag 40 during tire rolling (shown in dotted lines).

Accordingly, the indicator 10 can be formed of a substantially uniform material, designed primarily for secure fitment of the mount 50 to the rim's outer edge 60. Simply, the choice of material permits at least one of the gripping extensions 130B, 130A to flex over the outer edge 60 and yet retain sufficient gripping force to resist normal tire rotation forces, including some sidewall forces on corners. Typically the indicator 10 is formed of plastic such as “no break” plastic conforming to US military standards and specifications.

With reference to FIGS. 10C and 10D, in embodiments where the flag 40 rests on the sidewall S of the tire T, the indicator 10 must accommodate lateral movement of the sidewall that results from tire rolling. The flag 40 must flex somewhat with the sidewall S as shown in dotted lines in FIG. 10D, while the mount remains securely mounted to the rims' outer edge 60. In other words, pressure of the sidewall S on the flag, flexes the flag 40, and does not exert sufficient moment on the mount to pry the mount 50 form the rim's outer edge 60. The indicator can be manufactured of materials having a gradient of material properties, having a stronger material at the mount 50 and a more flexible material at the flag, having a transition therebetween, typically at the neck. Alternatively, the indicator can have a construction utilizing unitary materials, yet have a stronger structure at the mount 50 and weaker structure, such as by thinning, at the neck 80, flag 40 or both 80,40.

In one embodiment, the mount 50, neck 80 and flag 40 can be manufactured as individual components and assembled to form the indicator 10. The neck 80 can comprise biasing means to accommodate flexing of the flag. In another embodiment, the mount 50 can be manufactured from a resilient material that is sufficiently strong enough to maintain its grip on the rim's outer edge 60, the neck 80 can be manufactured from a different resilient material that permits flexing of the flag 40 away from the sidewall S. In another embodiment, the mounting means 50 and neck 80 can be manufactured of the same resilient material strong enough to maintain its grip, while the flag 40 can be made of a different resilient material that is more flexible than the mount 50 and permits flexing of the flag 40.

In another embodiment, and as shown in FIGS. 5A to 9, where the indicator 10 is of uni-body construction, the mounting means 50 must be manufactured from a material sufficiently stiff or strong enough to maintain a grip on the outer edge 60 of the rim all the while permitting the flag 40 to flex for accommodating the lateral movement of the sidewall S.

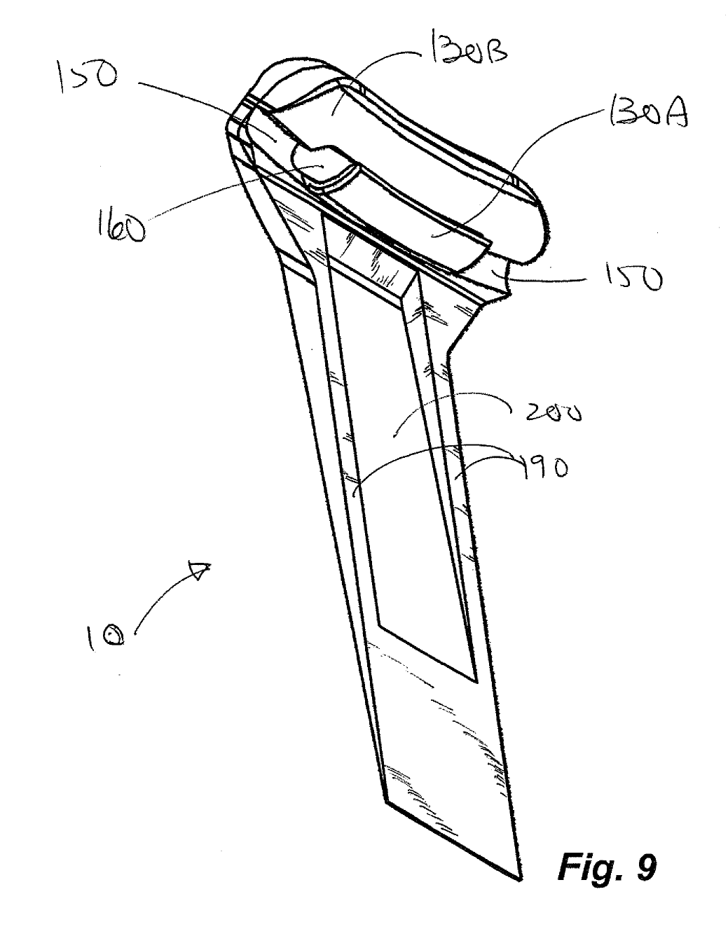

Yet, in another embodiment, and with reference to FIG. 7, the flag 40 can be tapered, having a thickness at a proximal end 170 that is substantially the same as the thickness of the distal end 100 of the neck 80, becoming more narrow as one approaches a distal end 180 of the flag 40. The narrowing of the flag 40 permits a range of choices of material for the flag 40, particularly those which may not necessarily be so resilient, yet sufficiently thin to permit the flag 40 to flex in response to lateral movement of the sidewall S. As shown in FIG. 9, in an embodiment, the tapered flag 40 can have gussets 190,190 placed along lateral edges 191,191 of the flag 40 on an interior surface 200 of the flag 40 to provide a balance between lightweight construction, yet providing necessary support to the flag 40.

In an embodiment, to improve the aerodynamic properties of the flag 40, the lateral edges 191,191 can be contoured or rounded.

Referring back to FIGS. 1 and 5B, and in an embodiment, indicators 10 can be mounted to multiple wheels 30 and tires T on a vehicle. In further embodiments, each wheel 30 can be mounted with two or more indicators 10,10. Each flag 40 can be positioned by its angled neck 80 to be substantially adjacent the sidewall S of the tire T. The angle 110 in the neck 80 further prevents the flag 40 from axially extending sufficiently beyond the plane P so as not to obstruct the view of indicators mounted onto wheels behind it. In an embodiment, the flag 40 can be thin in a plane parallel to the plane P defined the sidewall S to further reduce obstruction of indicators mounted onto wheels behind it.

Applicant notes that embodiments of the present invention can also be used as an indicator of low tire pressures. With reference to FIG. 10D and in similar action, a tire having low tire pressure would also be subject to lateral movement of its sidewalls as the weight of a vehicle compresses the tire and the sidewalls bulge laterally. The indicator mounted to the rim would flex in a similar fashion as when the sidewalls of the tire move laterally during tire rolling, forcing the indicator to flex.

An example of a commercial embodiment can comprise a replaceable indicator 10 having a flag that attaches or mounts to an outer edge of a rim of a vehicle wheel. The flag can be a fluorescent orange plastic tab that attaches to the outer rim edge of the vehicle wheel. This fluorescent plastic tab can be approximately 1½ inches wide and about 4 to 6 inches long. The indicator 10 can be replaceably attached to the outer rim edge by tapping with a hammer, attaching itself in a manner similar to that of a standard wheel balancing weight.

Further the arrangement of the indicator 10 permits use without interference from tire chains when affixed to the tire T.

This embodiment can be used on air-brake equipped trailers or vehicles whose wheels are subject to freeze-up, and skidding, due to condensation, air-line, or brake issues which would cause wheel lock up, permitting the vehicle operator or driver to determine whether all wheels are turning freely (not locked-up) by observing the replaceable indicator in their side view mirrors.

The embodiments of the invention for which an exclusive property or privilege is claimed are defined as follows:

1. A replaceable tire skid indicator for mounting on an outer edge of a rim of a wheel of a vehicle and visible to a driver in a cabin of the vehicle for indicating lock-up of a wheel, the indicator comprising:
a mount for releasably mounting the indicator to the rim's outer edge
a fluid passageway formed in the mount between the rim's outer edge and the mount;
a planer flag operatively connected to the mount and having a planer indicator surface visible to the driver, the planer flag extending generally radially along and substantially adjacent to a sidewall of the tire; and
a fluid drain formed between the fluid passageway and an exterior of the indicator,
wherein water flowing along the rim's outer edge is conducted along the fluid passageway to the fluid drain to drain water away from the rim's outer edge and mount to an exterior of the indicator.

2. The indicator of claim 1, wherein the mount comprises a U-clip having first and second gripping extensions, at least one of which is resilient, the first and second gripping extensions releasably gripping the rim's outer edge.

3. The indicator of claim 2, wherein when the rim's outer edge is gripped by the mount, a base of the U-clip is spaced away rim's outer edge for forming the fluid passageway therebetween.

4. The indicator of claim 1 further comprising a neck for operatively connecting the flag to the mount and having an angle sufficient for positioning the flag.

5. The indicator of claim 1, wherein the flag is spaced from the sidewall plane for substantially avoiding lateral movement of the sidewall of the tire during tire rolling.

6. The indicator of claim 1, wherein the flag rests on the sidewall of the tire for accommodating lateral movement of the sidewall of the tire during tire rolling.

7. The indicator of claim 6, wherein the neck is resilient for accommodating lateral movement of the sidewall of the tire during tire rolling.

8. The indicator of claim 6, wherein the mount and flag are formed of different materials, the flag being more flexible than that of the mount.

9. The indicator of claim 6, wherein a thickness of the flag is tapered, being thicker at an end proximal to the mount and becoming thinner towards a distal end for permitting flexing of the flag for accommodating lateral movement of the sidewall of the tire during rolling.

10. The indicator of claim 1, wherein the indicator surface further comprises a non-reflective high visible color.

11. The indicator of claim 9, wherein the flag further comprises gussets between the mount and the flag.

12. The indicator of claim 11, wherein the flag has lateral edges which are rounded for increasing aerodynamic properties of the flag.

13. A replaceable tire skid indicator for mounting on an outer edge of a rim of a wheel of a vehicle and visible to a driver in a cabin of the vehicle for indicating lock-up of a wheel, the indicator comprising:
a mount for releasably mounting the indicator to the rim's outer edge, the mount having a U-clip having first and second gripping extensions, at least one of which is resilient, the first and second gripping extensions releasably gripping the rim's outer edge; and
a planer flag operatively connected to the mount and having a planer indicator surface visible to the driver, the planer flag extending generally radially along and substantially adjacent to a sidewall of the tire, at least the flag being flexible for accommodating lateral movement of the sidewall of the tire during tire rolling.

14. The indicator of claim 13, wherein the mount and flag are formed of different materials, the flag being more flexible than that of the mount.

15. The indicator of claim 13, wherein a thickness of the flag is tapered, being thicker at an end proximal to the mount and becoming thinner towards a distal end for permitting flexing of the flag for accommodating lateral movement of the sidewall of the tire during rolling.
